(19) United States
(12) Patent Application Publication
(10) Pub. No.: US 2011/0273384 A1
(43) Pub. Date: Nov. 10, 2011

(54) ELECTROMAGNETIC ANTENNA LOOP LAYOUT

(76) Inventors: Yun-Hsiang YEH, Miaoli (TW); Sheng-Mao Lin, Tainan (TW)

(21) Appl. No.: 13/026,700

(22) Filed: Feb. 14, 2011

(30) Foreign Application Priority Data
May 5, 2010 (TW) 099114318

(51) Int. Cl. G06F 3/046; H01Q 21/00; H01Q 7/00

(52) U.S. Cl. 345/173; 343/867

(57) ABSTRACT

An electromagnetic antenna loop layout for use with an electromagnetic input apparatus is disclosed. The electromagnetic antenna loop layout comprises a plurality of electromagnetic antenna loops in parallel in each other, wherein each electromagnetic antenna loop has a first terminal connecting to a switch, and at least two adjacent electromagnetic antenna loops has a second terminal connecting to a common end (COM).

### 1. FIELD OF THE INVENTION

The present invention relates to an electromagnetic antenna loop layout, and more particularly to an electromagnetic antenna loop layout with integrated terminals of the antenna loops.

### 2. DESCRIPTION OF THE PRIOR ART

Conventional coordinate input apparatus such as a digitizer or a digital tablet usually include a pointer such as a stylus or an electromagnetic pen and an electromagnetic antenna loop layout. The electromagnetic antenna loop layout includes a plurality of sensor coils or antenna loops arranged along x and y axes to constitute an induction plane. The pointer usually includes a resonance circuit or signal receiving, processing and transmitting circuits therein depending on the types of the pointer. The coordinates of the pointer are obtained through the transmitting and receiving of electromagnetic signals between the pointer and the antenna loops.

Each sensor coil or antenna loop of the coordinate input apparatus comprises conductive lines to transmit electromagnetic signals to the pointer and receive electromagnetic signals from the pointer. Each antenna loop has two terminals. One of the terminals connects to a switch and finally to a control circuit, while the other terminal connects to a ground end (COM). As shown in FIG. 1, each of the antenna loops X₀˜X₁₁ along x axis has one terminal connecting to a switch and one terminal connecting to a ground end. Each of the antenna loops along y axis also has one terminal connecting to a switch and one terminal connecting to a ground end. The total number of the antenna loops on the electromagnetic antenna board includes the numbers of antenna loops along x and y axes respectively. If the number of antenna loops along x axis is Nx, and the number of antenna loops along y axis is Ny, the total number of the antenna loops is Nx+Ny. Since each antenna loop has two terminals, the total number of terminals of the antenna loops is 2(Nx+Ny).

The portions of each antenna loop connecting to the switch and the ground end occupy partial area of the electromagnetic antenna board of the coordinate input apparatus. The area of the electromagnetic antenna board occupied by the antenna loops is a detectable area where the coordinates of a pointer can be obtained through the transmitting and receiving of electromagnetic signals between the pointer and the antenna loops. The area of the electromagnetic antenna board occupied by the portions of each antenna loop connecting to the switch and the ground end is an undetectable area or an invalid area. Moreover, the sizes of the connector, the printed circuit board having the electromagnetic antenna board and the control circuit board depend on the total number of the terminals, and thus the total cost also increases as the total number of the terminals increases. Particularly for a large size coordinate input apparatus with a large number of antennal loops and terminals, how to enlarge the detectable area and to shrink the invalid area is a crucial issue.

In order to solve the above-mentioned drawbacks of the conventional electromagnetic antenna loop layout, a new electromagnetic antenna loop layout is thus provided to enlarge the detectable area and to shrink the invalid area.

### SUMMARY OF THE INVENTION

An object of the present invention is to provide a new electromagnetic antenna loop layout to reduce the total number of terminals such that the total number of terminals of the antenna loops can be decreased from 2(Nx+Ny) to 3/2(Nx+Ny).

According to the object, one embodiment of the present invention provides an electromagnetic antenna loop layout of an electromagnetic coordinate input apparatus. The electromagnetic antenna loop layout comprises a plurality of antenna loops parallel arranged along x and y axes, wherein a first terminal of each the antenna loop connects to a switch and second terminals of at least two adjacent antenna loops connect to a ground end.

The present invention further provides an electromagnetic coordinate input apparatus comprising a pointer, a micro controller, a signal processing circuit and an electromagnetic antenna loop layout. The electromagnetic antenna loop layout comprises a plurality of antenna loops arranged parallel to each other, wherein a first terminal of each the antenna loop connects to a switch and second terminals of every two antenna loops connect to a ground end, each the switch is controlled by the micro controller to switch the antenna loop to transmitting and receiving electromagnetic signals between the pointer and the electromagnetic antenna loop layout, the signal processing circuit processes the electromagnetic signals received by the antenna loops.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1 shows a conventional electromagnetic antenna loop layout.

FIGS. 2A-2D show schematic electromagnetic antenna loop layouts according to embodiments of the invention.

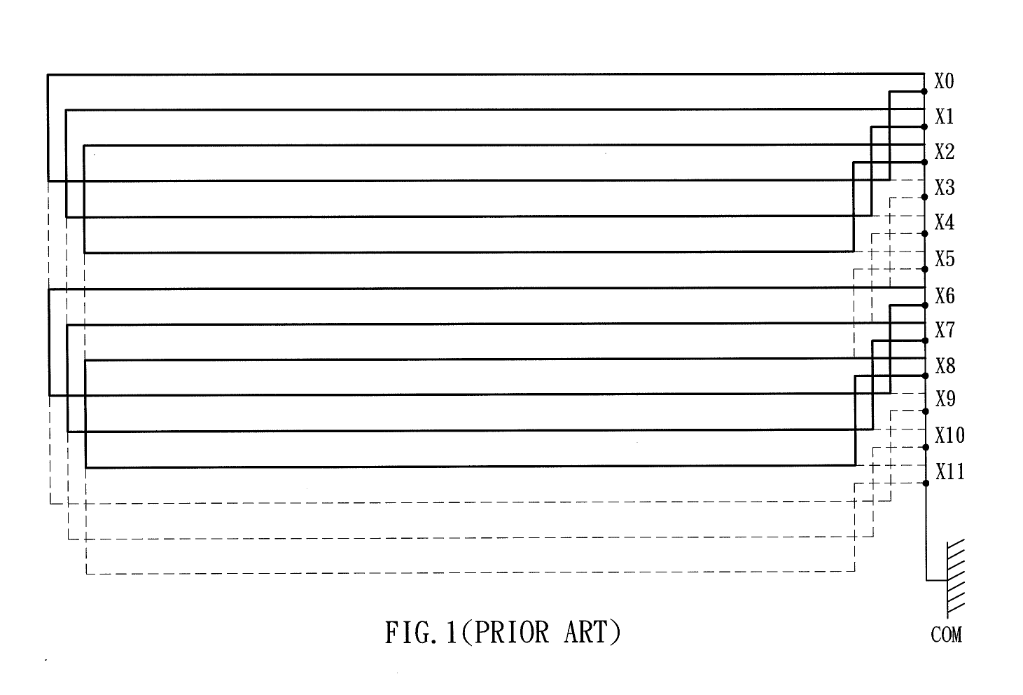

### DESCRIPTION OF THE PREFERRED EMBODIMENT

The detailed description of the present invention will be discussed in the following embodiments, which are not intended to limit the scope of the present invention, but can be adapted for other applications. While drawings are illustrated in details, it is appreciated that the scale of each component may not be expressly exactly.

In one embodiment of the invention, an electromagnetic coordinate input apparatus comprises a micro controller, a plurality of sensor coils or antenna loops arranged along x and y axes on an electromagnetic antenna board and a signal processing circuit including, but not limited to a signal amplifier, a filter, a rectifier, a phase detector and an analog to digital converter. The embodiment can be practiced via any well-known prior art, and one with ordinary skill in the art can make and use the invention based on ordinary level of skill. Each antenna loop on the electromagnetic antenna board connects to a switch controlled by a control circuit to switch the antenna loop to transmitting and receiving electromagnetic signals. The control circuit is drove by the micro controller. The control circuit controls a frequency generating circuit and a selecting circuit to switch and select antenna loops to transmit electromagnetic signals. The electromagnetic signals are transmitted to a pointer to resonate with a resonance circuit (batteryless pointer) or to activate a control circuit of the pointer (pointer with battery) to transmit electromagnetic signals. When the antenna loops temporarily interrupt transmitting electromagnetic signals, the pointer transmits electromagnetic signals back to the antenna loops and received by the antenna loops. The electromagnetic signals received by the antenna loops are then processed and analyzed by the signal amplifier, the filter, the rectifier, the phase detector and the analog to digital converter.

When the pointer moves on the electromagnetic antenna board, the pointers and the antennas loops repeatedly transmit and receive signals continuously and alternatively.

The antenna loops on the trace of the pointer are switched by the micro controller sequentially to transmit and receive signals continuously and alternatively. The micro controller sequentially switching the antenna loops is also referred as scanning. The sequentially switching of the antenna loops is performed by multiplexers controlled by the micro controller.

The position detection of the pointers begins from detecting no any signals from the pointers to completely calculating the coordinates of the pointers including x and y coordinates. The micro controller controls a signal/frequency generating circuit and a selection circuit to sequentially switch the antenna loops to transmit and receive signals alternatively to perform a full region scan, and thus any signal received by any antenna loop can be detected and processed. If the pointers are on the detection region of the electromagnetic antenna board, the antenna loops corresponding to the positions of the pointers will receive signals with maximum values, and thus the positions of the pointers can be roughly located. Then the micro controller controls the signal/frequency generating circuit and the selection circuit to sequentially switch the antenna loops within a certain region with the position of the pointer as the center to transmit and receive signals alternatively to perform a partial region scan. The partial region scan only switches the antenna loops adjacent the antenna loops receiving the signals with maximum values to transmit and receive signals. The coordinates of the pointers are located if signals with maximum values are received and the accurate coordinates of the pointers are calculated through further signal processing.

Each antenna loop of the electromagnetic antenna board has two terminals, wherein one of the terminals connects to a switch and finally to a control circuit, while the other terminal connects to a ground end (COM). The portions of each antenna loop connecting to the switch and the ground end occupy partial area of the electromagnetic antenna board of the coordinate input apparatus. The area of the electromagnetic antenna board occupied by the antenna loops is a detectable area where the coordinates of a pointer can be obtained through the transmitting and receiving of electromagnetic signals between the pointer and the antenna loops. The area of the electromagnetic antenna board occupied by the portions of each antenna loop connecting to the switch and the ground end is an invalid area. For a coordinate input apparatus, the detectable area must be enlarged and the invalid area must be decreased.

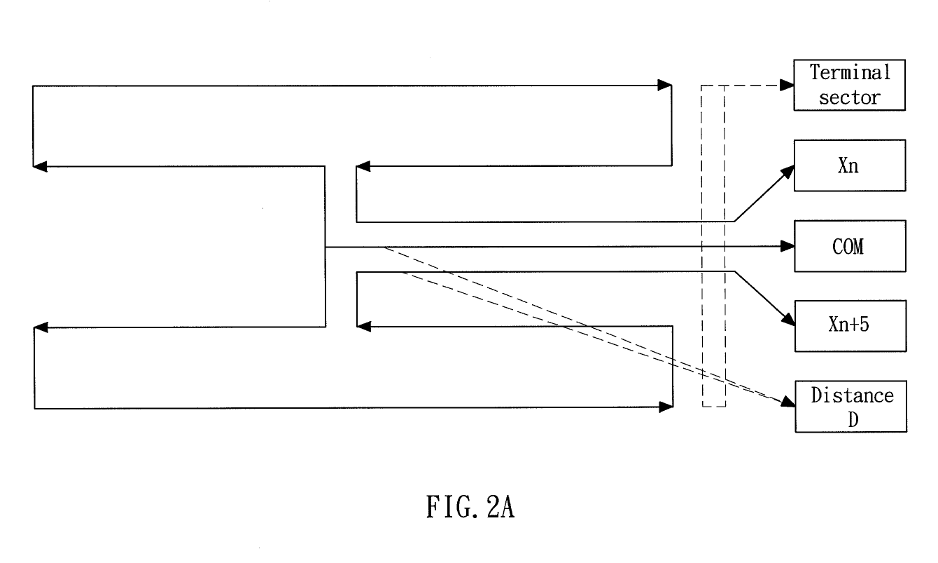

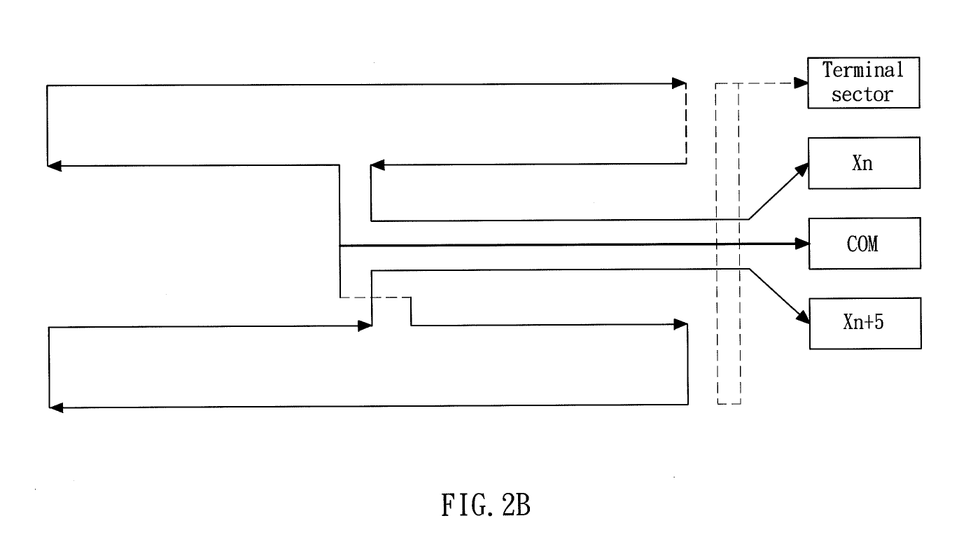

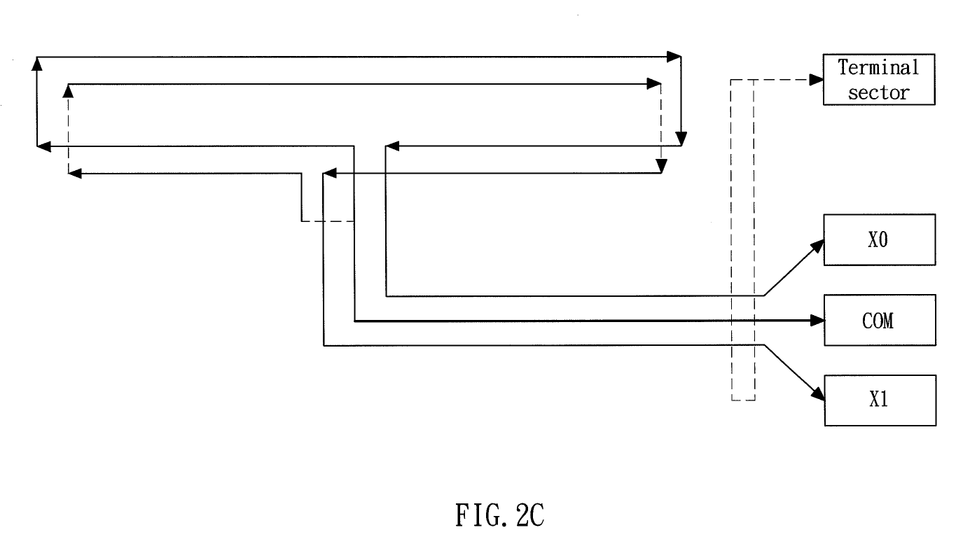

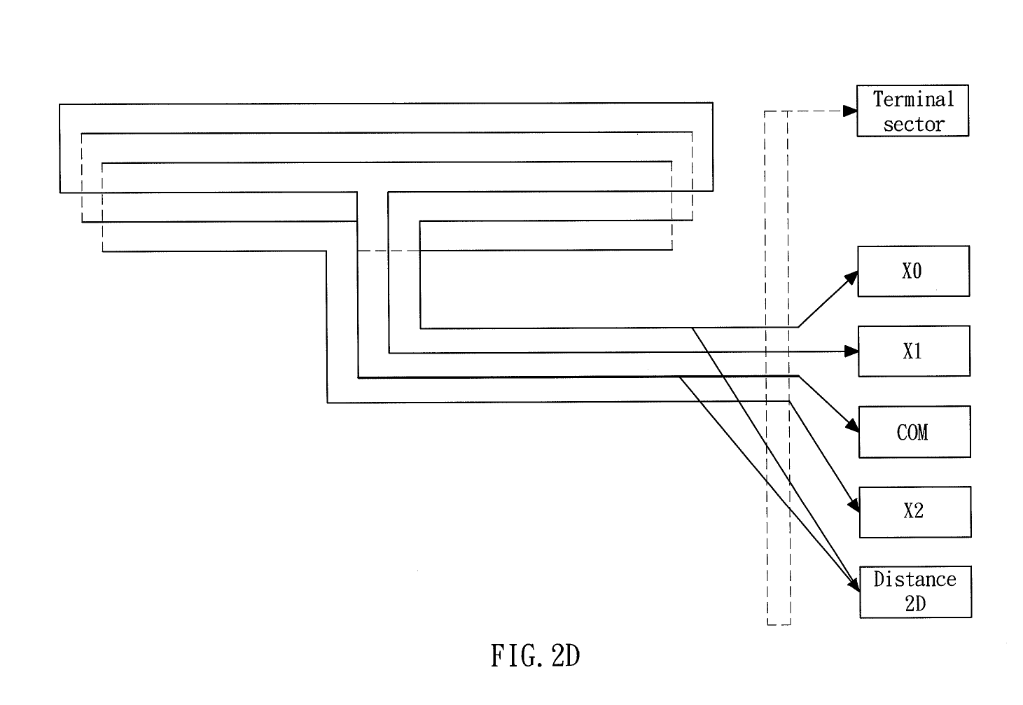

FIG. 2A shows a schematic electromagnetic antenna loop layout according to one embodiment of the invention. As shown in FIG. 2A, each antenna loop has two terminals, wherein one terminal connects to a reference level or a ground end (COM) and the other terminal connects to signal processing circuits or the signal/frequency generating circuit selected by multiplexers of the selection circuit. Every two antenna loops share a common terminal connecting to the ground end (COM) which means that one terminal can be omitted every two antenna loops. As shown in FIG. 2A, antenna loops Xₙ and Xₙ₊₅ are aligned parallel to each other, wherein both first terminals of the antenna loops Xₙ and Xₙ₊₅ connect to switches (not shown), and second terminals of the antenna loops Xₙ and Xₙ₊₅ connect to a ground end (COM). The first terminal and the portions of the antenna loops Xₙ and Xₙ₊₅ connecting to the switches and the second terminals and the portions of the antenna loops Xₙ and Xₙ₊₅ connecting to the ground end (COM) are between the antenna loops Xₙ and Xₙ₊₅, and the directions of induced currents in the antenna loops Xₙ and Xₙ₊₅ are contrary. The distance D between the antenna loops Xₙ and Xₙ₊₅ is theoretically as minimum as possible so that unnecessary signals will not be detected. Thus a minimum distance between the antenna loops with a common terminal connecting to a ground end can be achieved by locating two terminal connecting to switches on two opposing sides of the common terminal connecting to a ground end.

FIG. 2B shows another schematic electromagnetic antenna loop layout according to another embodiment of the invention. Although the electromagnetic antenna loop layout with the antenna loops Xₙ and Xₙ₊₅ shown in FIG. 2A can significantly reduce the number the terminals, but the directions of induced currents in the antenna loops Xₙ and Xₙ₊₅ are contrary. The contrary directions of the induced currents in the antenna loops Xₙ and Xₙ₊₅ could not achieve synchronization of the phases of the alternating induced current. Actually the contrary directions of induced currents in the antenna loops Xₙ and Xₙ₊₅ cause opposing phases of the alternating induced current and result in error of signal/frequency processing. In order to overcome this drawback, as shown in FIG. 2B, a crossover of the antenna loop Xₙ₊₅ is used so that the directions of induced currents in the antenna loops Xₙ and Xₙ₊₅ are the same. The first terminals and the portions of the antenna loops Xₙ and Xₙ₊₅ connecting to the switches are located on the two opposing sides of the second terminals respectively and the portions of the antenna loops Xₙ and Xₙ₊₅ connecting to the ground end (COM),

FIG. 2C shows another schematic electromagnetic antenna loop layout according to another embodiment of the invention. In FIG. 2C two antenna loops X₀ and X₁ are both located on the upper portion. The directions of induced currents in the antenna loops X₀ and X₁ are the same, and the first terminal and the portions of the antenna loops X₀ and X₁ connecting to the switches and the second terminals and the portions of the antenna loops X₀ and X₁ connecting to the ground end (COM) are at one side of the antenna loops X₀ and X₁. As the antenna loops Xₙ₊₅ shown in FIG. 2B, the antenna loop X₁ also includes a crossover, and the first terminals and the portions of the antenna loops X₀ and X₁ connecting to the switches are located on the two opposing sides of the second terminals and the portions of the antenna loops X₀ and X₁ connecting to the ground end (COM),

FIG. 2D shows another schematic electromagnetic antenna loop layout according to another embodiment of the invention. In FIG. 2D, three antenna loops X₀, X₁, and X₂ share a common terminal connecting to a ground end (COM), and the distance 2D between the antenna loop X₀ and the second terminals and the portions of the antenna loops X₀, X₁, and X₂ connecting to the ground end (COM) may cause unnecessary signal noises. Similar to the antenna loops X₀ and X₁, the first terminals and the portions of the antenna loops X₀, X₁, and X₂ connecting to the switches and the second terminals and the portions of the antenna loops X₀, X₁, and X₂ connecting to the ground end (COM) are at one side of the antenna loops X₀, X₁, and X₂. If more than two antenna loops are combined to share one common terminal connecting to a ground end (COM), the distance between the first terminal and the portion of one antenna loop connecting to a switch and the second terminals and the portions of the antenna loops connecting to the ground end (COM) will be increased to cause more unnecessary signal noises.

Although specific embodiments have been illustrated and described, it will be appreciated by those skilled in the art that various modifications may be made without departing from the scope of the present invention, which is intended to be limited solely by the appended claims.

What is claimed is:

1. An electromagnetic antenna loop layout of an electromagnetic coordinate input apparatus, said electromagnetic antenna loop layout comprising:
a plurality of antenna loops parallel arranged along x and y axes, wherein a first terminal of each the antenna loop connects to a switch and second terminals of at least two adjacent antenna loops connect to a ground end.

2. The electromagnetic antenna loop layout of an electromagnetic coordinate input apparatus according to claim 1, wherein the directions of induced currents in the at least two adjacent antenna loops are the same.

3. The electromagnetic antenna loop layout of an electromagnetic coordinate input apparatus according to claim 1, wherein the directions of induced currents in the at least two adjacent antenna loops are contrary.

4. The electromagnetic antenna loop layout of an electromagnetic coordinate input apparatus according to claim 1, wherein the first terminals and portions of the adjacent antenna loops connecting to the switches and the second terminals and portions of the adjacent antenna loops connecting to the ground end are between the adjacent antenna loops.

5. The electromagnetic antenna loop layout of an electromagnetic coordinate input apparatus according to claim 1, wherein the first terminals and portions of the two adjacent antenna loops connecting to the switches and the second terminals and portions of the two adjacent antenna loops connecting to the ground end are at one side of the adjacent antenna loops.

6. The electromagnetic antenna loop layout of an electromagnetic coordinate input apparatus according to claim 1, wherein the first terminals of the two adjacent antenna loops are located on the two opposing sides of the second terminals.

7. An electromagnetic coordinate input apparatus, comprising:
a micro controller and a signal processing circuit;
a pointer; and
an electromagnetic antenna loop layout comprising:
a plurality of antenna loops arranged parallel to each other, wherein a first terminal of each the antenna loop connects to a switch and second terminals of every two antenna loops connect to a ground end, each the switch is controlled by the micro controller to switch the antenna loop to transmitting and receiving electromagnetic signals between the pointer and the electromagnetic antenna loop layout, the signal processing circuit processes the electromagnetic signals received by the antenna loops.

8. The electromagnetic coordinate input apparatus according to claim 7, wherein the first terminals and portions of the two adjacent antenna loops connecting to the switches and the second terminals and portions of the two adjacent antenna loops connecting to the ground end are at one side of the two adjacent antenna loops.

9. The electromagnetic coordinate input apparatus according to claim 7, wherein the first terminals of the two adjacent antenna loops are located on the two opposing sides of the second terminals and portions of the two adjacent antenna loops connecting to the ground end.

10. The electromagnetic coordinate input apparatus according to claim 7, wherein the first terminals and portions of the two adjacent antenna loops connecting to the switches and the second terminals and portions of the two adjacent antenna loops connecting to the ground end are between the adjacent antenna loops.
